(19) United States
(12) Patent Application Publication
(10) Pub. No.: US 2005/0196023 A1
(43) Pub. Date: Sep. 8, 2005

(54) Method for real-time remote diagnosis of in vivo images

(75) Inventors: Shoupu Chen, Rochester, NY (US); Lawrence A. Ray, Rochester, NY (US); Nathan D. Cahill, West Henrietta, NY (US); Marvin M. Goodgame, Ontario, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/790,478

(22) Filed: Mar. 1, 2004

(51) Int. Cl. G06K 9/00

(52) U.S. Cl. 382/128

(57) ABSTRACT

A digital image processing method for real-time automatic abnormality notification of in vivo images and remote access of in vivo imaging system, comprising the steps of: acquiring multiple sets of images using multiple in vivo video camera systems; for each in vivo video camera system forming an in vivo video camera system examination bundlette; transmitting the examination bundlette to proximal in vitro computing device(s); processing the transmitted examination bundlette; automatically identifying abnormalities in the transmitted examination bundlette; setting off alarming signals locally provided that suspected abnormalities have been identified; receiving one or more unscheduled alarming messages from one or more endoscopic imaging systems randomly located; routing alarming messages to remote recipient(s); and executing one or more corresponding tasks in relation to the alarming messages.

### FIELD OF THE INVENTION

The present invention relates generally to an endoscopic imaging system and, in particular, to real-time automatic abnormality notification of in vivo images and remote access of in vivo imaging system.

### BACKGROUND OF THE INVENTION

Several in vivo measurement systems are known in the art. They include swallowed electronic capsules which collect data and which transmit the data to an external receiver system. These capsules, which are moved through the digestive system by the action of peristalsis, are used to measure pH (“Heidelberg” capsules), temperature (“CoreTemp” capsules) and pressure throughout the gastro-intestinal (GI) tract. They have also been used to measure gastric residence time, which is the time it takes for food to pass through the stomach and intestines. These capsules typically include a measuring system and a transmission system, wherein the measured data is transmitted at radio frequencies to a receiver system.

U.S. Pat. No. 5,604,531, assigned to the State of Israel, Ministry of Defense, Armament Development Authority, and incorporated herein by reference, teaches an in vivo measurement system, in particular an in vivo camera system, which is carried by a swallowed capsule. In addition to the camera system there is an optical system for imaging an area of the GI tract onto the imager and a transmitter for transmitting the video output of the camera system. The overall system, including a capsule that can pass through the entire digestive tract, operates as an autonomous video endoscope. It images even the difficult to reach areas of the small intestine.

U.S. patent application Ser. No. 2003/0023150 A1, assigned to Olympus Optical Co., LTD., and incorporated herein by reference, teaches a swallowed capsule-type medical device which is advanced through the inside of the somatic cavities and lumens of human beings or animals for conducting examination, therapy, or treatment. Signals including images captured by the capsule-type medical device are transmitted to an external receiver and recorded on a recording unit. The images recorded are retrieved in a retrieving unit, displayed on the liquid crystal monitor and to be compared by an endoscopic examination crew with past endoscopic disease images that are stored in a disease image database.

The examination requires the capsule to travel through the GI tract of an individual, which will usually take a period of many hours. A feature of the capsule is that the patient need not be directly attached or tethered to a machine and may move about during the examination. While the capsule will take several hours to pass through the patient, images will be recorded and will be available while the examination is in progress. Consequently, it is not necessary to complete the examination prior to analyzing the images for diagnostic purposes. However, it is unlikely that trained personnel will monitor each image as it is received. This process is too costly and inefficient. However, the same images and associated information can be analyzed in a computer-assisted manner to identify when regions of interest or conditions of interest present themselves to the capsule. When such events occur, then trained personnel will be alerted and images taken slightly before the point of the alarm and for a period thereafter can be given closer scrutiny. Another advantage of this system is that trained personnel are alerted to an event or condition that warrants their attention. Until such an alert is made, the personnel are able to address other tasks, perhaps unrelated to the patient of immediate interest.

Using computers to examine and to assist in the detection from images is well known. Also, the use of computers to recognize objects and patterns is also well known in the art. Typically, these systems build a recognition capability by training on a large number of examples. The computational requirements for such systems are within the capability of commonly available desk-top computers. Also, the use of wireless communications for personal computers is common and does not require excessively large or heavy equipment. Transmitting an image from a device attached to the belt of the patient is well-known.

Notice that 0023150 teaches a method of storing the in vivo images first and retrieving them later for visual inspection of abnormalities. The method lacks of abilities of prompt and real-time automatic detection of abnormalities, which is important for calling a physicians' immediate attentions and actions including possible adjustment of the in vivo imaging system's functionality. Notice also that, in general, using this type of capsule device, one round of imaging could produce thousands and thousands of images to be stored and visually inspected by the medical professionals. Obviously, the inspection method taught by 0023150 is far from efficient.

There are remote medical operation endoscopic support systems such as the one described in U.S. Pat. No. 6,490,490, B1, assigned to Olympus Optical Co., LTD., and incorporated herein by reference. This system teaches a method with that a physician in a remote place views endoscopic images displayed in an operating room over a communication line. The physician can change an image area or a viewing direction represented by endoscopic images in a desired manner by performing manipulations. Apparently, this is a stationed or constrained remote medical operation support system. Subjects involved in the system are tethered to specific locations. Also remote operations in this type of systems are scheduled events. Subjects involved in the system are given specific time slots to present in the specific locations so that the scheduled events can take place. Noticeably, these endoscopic imaging systems have dedicated one to one remote connections.

In the situation of real-time automatic abnormality detection of in vivo images, it is possible that multiple in vivo imaging systems are in operation at any given time. Detection of abnormality is essentially a random event. Patients using the in vivo imaging system should be allowed to present not only in places where medical personnel residing, but also places such as homes and offices.

It is useful to design a remote endoscopic imaging diagnostic system that is capable of detecting abnormality in real-time and detecting abnormality automatically. The remote system is also capable of accepting unscheduled events (random alarming messages) in unconstrained locations. Moreover, the remote system can accommodate multiple endoscopic imaging sources and distribute unscheduled events to available receivers of different types in two-way communications, and medical staff at the remote site can access and manipulate in vivo imaging systems accordingly.

There is a need therefore for an improved endoscopic imaging system that overcomes the problems set forth above.

These and other aspects, objects, features and advantages of the present invention will be more clearly understood and appreciated from a review of the following detailed description of the preferred embodiments and appended claims, and by reference to the accompanying drawings.

### SUMMARY OF THE INVENTION

The need is met according to the present invention by proving a digital image processing method for real-time automatic abnormality notification of in vivo images and remote access of in vivo imaging system that includes the steps of: acquiring multiple sets of images using multiple in vivo video camera systems; for each in vivo video camera system forming an in vivo video camera system examination bundlette; transmitting the examination bundlette to proximal in vitro computing device(s); processing the transmitted examination bundlette; automatically identifying abnormalities in the transmitted examination bundlette; setting off alarming signals locally provided that suspected abnormalities have been identified; receiving one or more unscheduled alarming messages from one or more endoscopic imaging systems randomly located; routing alarming messages to remote recipient(s); and executing one or more corresponding tasks in relation to the alarming messages.

### BRIEF DESCRIPTION OF THE DRAWINGS

FIG. 1 (PRIOR ART) is a block diagram illustration of an in vivo camera system.

FIG. 2A is an illustration of the concept of an examination bundle of the present invention.

FIG. 2B is an illustration of the concept of an examination bundlette of the present invention.

FIG. 3 is a flowchart illustrating information flow of the real-time abnormality detection method of the present invention.

FIG. 4 is a schematic diagram of an examination bundlette processing hardware system useful in practicing the present invention.

FIG. 5 is a flowchart illustrating abnormality detection of the present invention.

FIG. 6 is a flowchart illustrating image feature examination of the present invention.

FIG. 7 is a flowchart illustrating thresholding operations.

FIG. 8 is an illustration of four images related to in vivo image abnormality detection of the present invention.

FIG. 9 is a flowchart illustrating color feature detection of the present invention.

FIG. 10 is an illustration of two graphs of generalized RG space of the present invention.

FIG. 11A is an illustration of a binary signal.

FIG. 11B is an illustration of the concept of an alarming message.

FIG. 12 is a flowchart illustrating the functionalities of a messaging unit.

FIG. 13 is a flowchart illustrating a remote site and multiple sources.

FIG. 14 is a flowchart illustrating the functionalities of the remote site.

FIG. 15 is a flowchart illustrating a path from transmitting end to a receiving end of a communication path for transmitting a message.

FIG. 16 is a schematic diagram of real-time automatic abnormality notification of in vivo images and remote access of in vivo imaging system of the present invention.

FIG. 17 is an illustration of the concept of an instruction message.

FIG. 18 is a schematic diagram of an image/message processing hardware system useful in practicing the present invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

During a typical examination of a body lumen, the in vivo camera system captures a large number of images. The images can be analyzed individually, or sequentially, as frames of a video sequence. An individual image or frame without context has limited value. Some contextual information is frequently available prior to or during the image collection process; other contextual information can be gathered or generated as the images are processed after data collection. Any contextual information will be referred to as metadata. Metadata is analogous to the image header data that accompanies many digital image files.

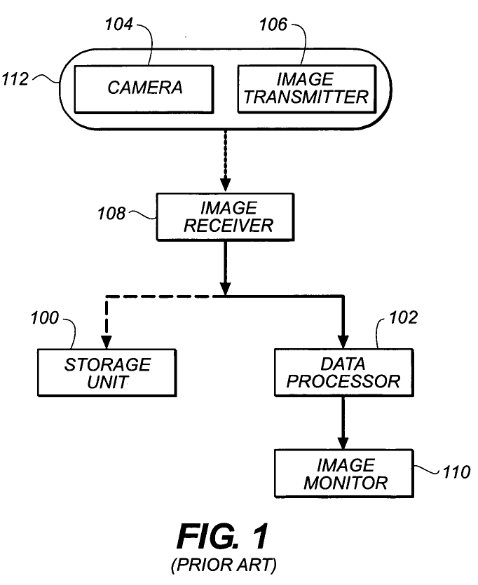

FIG. 1 shows a block diagram of the in vivo video camera system described in U.S. Pat. No. 5,604,531. The system captures and transmits images of the GI tract while passing through the gastro-intestinal lumen. The system contains a storage unit 100, a data processor 102, a camera 104, an image transmitter 106, an image receiver 108, which usually includes an antenna array, and an image monitor 110. Storage unit 100, data processor 102, image monitor 110, and image receiver 108 are located outside the patient's body. Camera 104, as it transits the GI tract, is in communication with image transmitter 106 located in capsule 112 and image receiver 108 located outside the body. Data processor 102 transfers frame data to and from storage unit 100 while the former analyzes the data. Processor 102 also transmits the analyzed data to image monitor 110 where a physician views it. The data can be viewed in real time or at some later date.

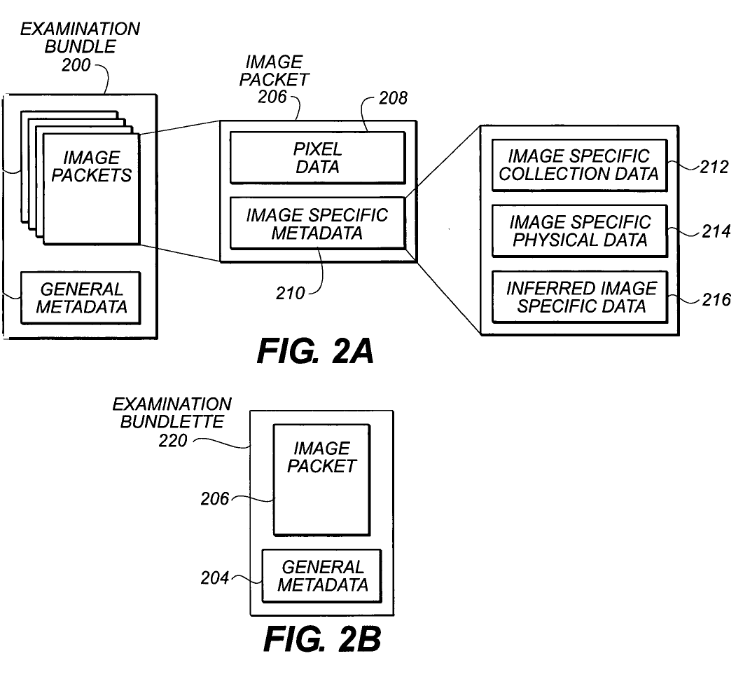

Referring to FIG. 2A, the complete set of all images captured during the examination, along with any corresponding metadata, will be referred to as an examination bundle 200. The examination bundle 200 consists of a collection of image packets 202 and a section containing general metadata 204.

An image packet 206 comprises two sections: the pixel data 208 of an image that has been captured by the in vivo camera system, and image specific metadata 210. The image specific metadata 210 can be further refined into image specific collection data 212, image specific physical data 214 and inferred image specific data 216. Image specific collection data 212 contains information such as the frame index number, frame capture rate, frame capture time, and frame exposure level. Image specific physical data 214 contains information such as the relative position of the capsule when the image was captured, the distance traveled from the position of initial image capture, the instantaneous velocity of the capsule, capsule orientation, and non-image sensed characteristics such as pH, pressure, temperature, and impedance. Inferred image specific data 216 includes location and description of detected abnormalities within the image, and any pathologies that have been identified. This data can be obtained either from a physician or by automated methods.

The general metadata 204 contains such information as the date of the examination, the patient identification, the name or identification of the referring physician, the purpose of the examination, suspected abnormalities and/or detection, and any information pertinent to the examination bundle 200. It can also include general image information such as image storage format (e.g., TIFF or JPEG), number of lines, and number of pixels per line.

Referring to FIG. 2B, the image packet 206 and the general metadata 204 are combined to form an examination bundlette 220 suitable for real-time abnormality detection.

It will be understood and appreciated that the order and specific contents of the general metadata or image specific metadata may vary without changing the functionality of the examination bundle.

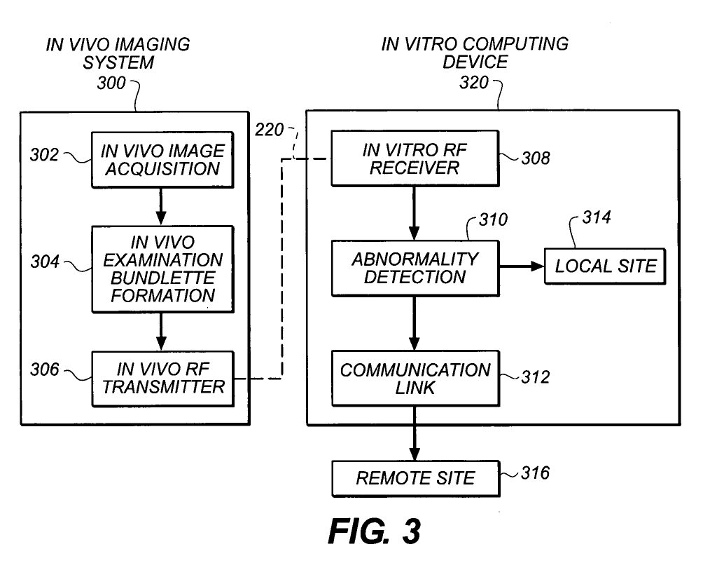

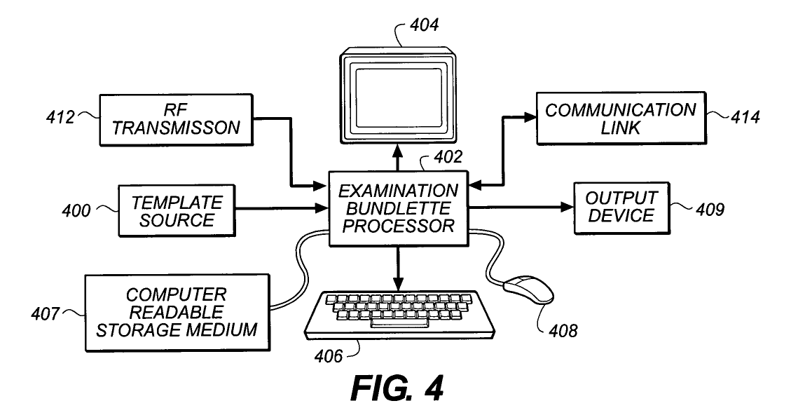

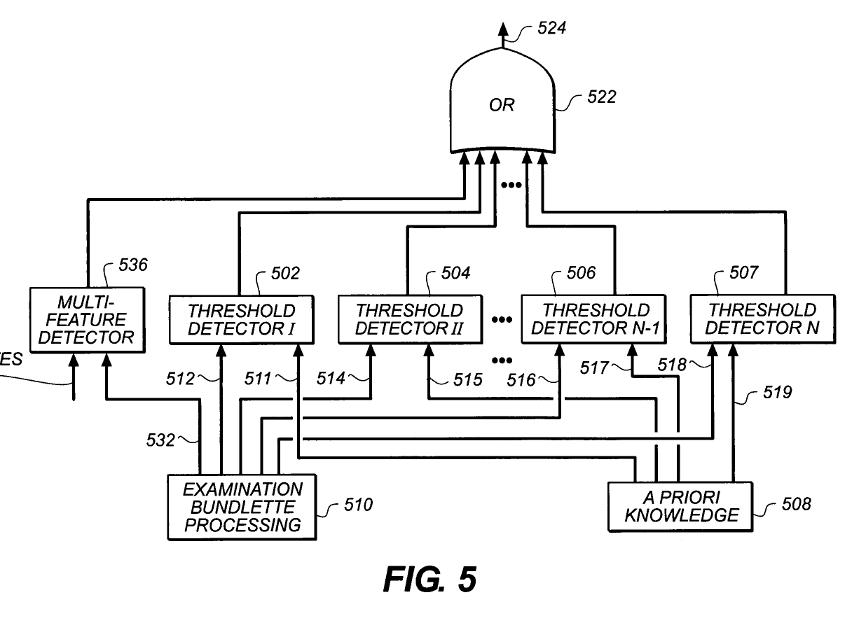

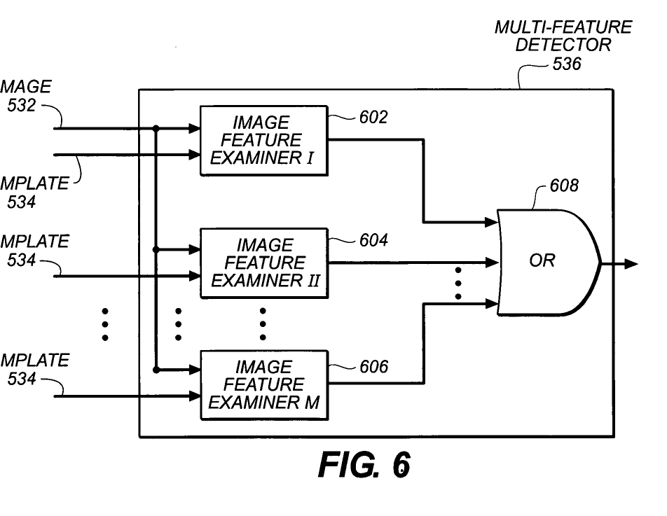

Referring now to FIG. 3, an embodiment of the automatic abnormality detection of in vivo images of the present invention will be described. FIG. 3 is a flowchart illustrating the real-time automatic abnormality detection method of the present invention. In FIG. 3, an in vivo imaging system 300 can be realized by using systems such as the swallowed capsule described in U.S. Pat. No. 5,604,531 for the present invention. An in vivo image 208 is captured in an in vivo image acquisition step 302. In a step of In Vivo Examination Bundlette Formation 304, the image 208 is combined with image specific data 210 to form an image packet 206. The image packet 206 is further combined with general metadata 204 and compressed to become an examination bundlette 220. The examination bundlette 220 is transmitted to a proximal in vitro computing device through radio frequency in a step of RF transmission 306. An in vitro computing device 320 is either a portable computer system attached to a belt worn by the patient or in near proximity. Alternatively, it is a system such as shown in FIG. 4 and will be described in detail later. The transmitted examination bundlette 220 is received in the proximal in vitro computing device in a step of In Vivo RF Receiver 308. Data received in the in vitro computing device is examined for any sign of disease in a step of Abnormality detection 310. The step of Abnormality detection 310 is further detailed in FIG. 5. The Examination Bundlette is first decompressed, decomposed and processed in the Examination Bundlette processing step 510. In this step, the image data portion of the Examination Bundlette is subjected to image processing algorithms such as filtering, enhancing, and geometric correction. There are a plurality of threshold detectors, each handling one of the non-image sensed characteristics in the GI tract such as pH 512, pressure 514, temperature 516 and impedance 518. Distributions and thresholds of the non-image sensed characteristics such as pH 512, pressure 514, temperature 516 and impedance 518 are learned in a step of a priori knowledge 508. If values of the non-image sensed characteristics such as pH 512, pressure 514, temperature 516 and impedance 518 pass over their respective thresholds 511, 515, 517, and 519, corresponding alarm signals are sent to a logic OR gate 522. Also in FIG. 5, there is a Multi-feature Detector 534 which is detailed in FIG. 6. There is a plurality of image feature detectors in FIG. 6, each of which examines one of the image features of interest. Image features such as color, texture, and geometric shape of segmented regions of the GI tract image 532 are extracted and automatically compared to predetermined templates 534. The predetermined templates 534 are statistical representations of GI image abnormality features through supervised learning. If any one of the multi-features in image 532 matches its corresponding template or within the ranges specified by the templates, an OR gate 608 sends an alarm signal to the OR gate 522.

Any combination of the alarm signals from detectors 534, 502, 504, 506 and 507 will prompt the OR gate 522 to send a signal 524 to a local site 314 and to a remote health care site 316 through communication connection 312. An exemplary communication connection 312 could be a broadband network connected the in vitro computing system 320. The connection from the broadband network to the in vitro computing system 320 could be either a wired connection or a wireless connection.

An exemplary image feature detection is the color detection for Hereditary Hemorrhagic Telangiectasia disease. Hereditary Hemorrhagic Telangiectasia (HHT), or Osler-Weber-Rendu Syndrome, is not a disorder of blood clotting or missing clotting factors within the blood (like hemophilia), but instead is a disorder of the small and medium sized arteries of the body. HHT primarily affects four organ systems: the lungs, brain, nose and gastrointestinal (stomach, intestines or bowel) system. The affected arteries either have an abnormal structure causing increased thinness or an abnormal direct connection with veins (arteriovenous malformation). Gastrointestinal Tract (Stomach, Intestines or Bowel) bleeding occurs in approximately 20 to 40% of persons with HHT. Telangiectasias often appear as bright red spots in Gastrointestinal Tract.

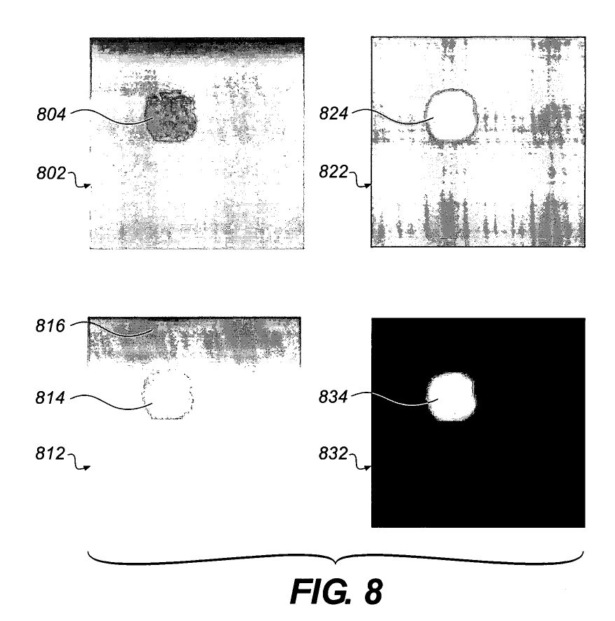

A simulated image of a telangiectasia 804 on a gastric fold is shown in image 802 in FIG. 8. To human eyes, the red component of the image provides distinct information for identifying the telangiectasia on the gastric fold. However, for the automatic telangiectasia detection using a computer, the native red component (image 812) of the color image 802, in fact, is not able to clearly distinguish the foreground (telangiectasia 814) and the part of the background 816 of image 812 in terms of pixel values.

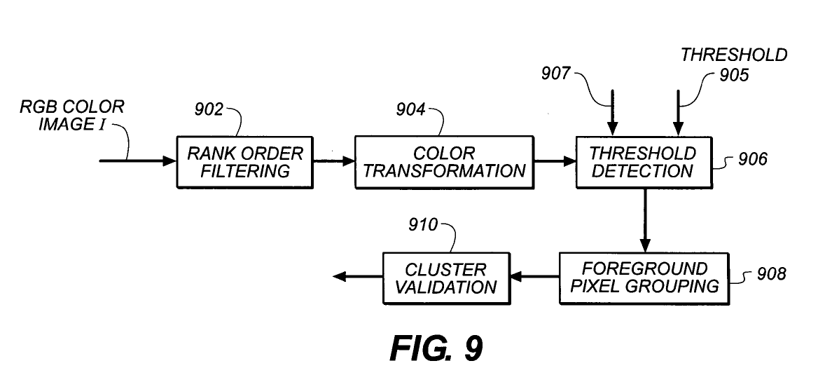

To solve the problem, the present invention devises a color feature detection algorithm that detects the telangiectasia 804 automatically in an in vivo image. Referring to FIG. 9, the color feature detection performed according to the present invention by the Multi-feature Detector 534 will be described. The digital image, expressed in a device independent RGB color space is first filtered in a median filtering (Rank Order Filtering) step 902. Denote the input RGB image by I_{RGB}={Cᵢ}, where i=1,2,3 for R, G, and B color planes respectively. A pixels at location (m, n) in a plane Cᵢ is represented by pᵢ (m, n), where m=0, . . . M−1 and n=0, . . . N−1,
M is the number of rows, and N is the number of columns in a plane. Exemplary values for M and N are 512 and 768.
The median filtering is defined as

$${p}_{i} ( m , n ) = \{ \begin{matrix}median ( {C}_{i} , m , n , S , T ) {\vert}_{median ( {C}_{i} , m , n , S , T ) > {T}_{Low}} \\ 0 {\vert}_{otherwise}\end{matrix} \qquad ( 1 )$$

where T_{Low} is a predefined threshold. An exemplary value for T_{Low} is 20. S and T are the width and height of the median operation window. Exemplary values for S and T are 3 and 3. This operation is similar to the traditional process of trimmed median filtering well known to people skilled in the art. Notice that the purpose of the median filtering in the present invention is not to improve the visual quality of the input image as traditional image processing does; rather, it is to reduce the influence of a patch or patches of pixels that have very low intensity values on the decision making stage (Threshold Detection) 906. A patch of low intensity pixels is usually caused by a limited illumination power and a limited view distance of the in vivo imaging system as it heads down to an opening of an organ in the GI tract.

In step of Color Transformation 904, after the media filtering, I_{RGB} is converted to a generalized RGB image, I_{gRGB}, using the formula:

$${\overline{p}}_{j} ( m , n ) = \frac{{p}_{j} ( m , n )}{{\sum }_{i} {p}_{i} ( m , n )} \qquad ( 2 )$$

where pᵢ (m, n) is a pixel of an individual image plane i of the media filtered image I_{RGB}. \overline{p}ᵢ (m, n) is a pixel of an individual image plane i of the resultant image I_{gRGB}. This operation is not valid when Σpᵢ(m, n)=0, and the output, \overline{p}ᵢ(m, n), will be set to zero. The resultant three new elements are linearly dependent, that is, Σ\overline{p}ⱼ(m, n)=0, so that only two elements are needed to effectively form a new space that is collapsed from three dimensions to two dimensions. In most cases, \overline{p}₁ and \overline{p}₂, that is, generalized R and G, are used. In the present invention, to detect a telangiectasia 804, the generalized R component is needed. Image 822 in FIG. 8 displays the generalized R component of the image 802. Clearly, pixels in region 824 of image 822 have distinguishable values comparing to pixels in the background region. Therefore, a simple thresholding operation 906 can separate the pixels in the foreground (telangiectasia) from the background.

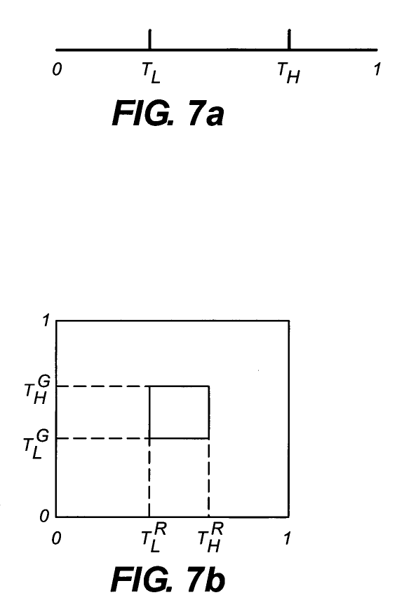

It is not a trivial task to parameterize the sub-regions of thresholding color in (R, G, B) space. With the help of color transformation 904, the generalized R color is identified to be the parameter to separate a disease region from a normal region. A histogram of the generalized R color of disease region pixels and the normal region pixels provides useful information for partitioning the disease region pixels and the normal region pixels. The histogram is a result of a supervised learning of sample disease pixels and normal pixels in the generalized R space. A measured upper threshold parameter T_{H} 905 (part of 534) and a measured lower threshold parameter T_{L} 907 (part of 534) obtained from the histogram are used to determine if an element \overline{p}ᵢ(m, n) is a disease region pixel (foreground pixel) or a normal region pixel:

$$b ( m , n ) = \{ \begin{matrix}1 & if {T}_{L} < {\overline{p}}_{1} ( m , n ) < {T}_{H} \\ 0 & else\end{matrix} \qquad ( 3 )$$

where b(m, n) is an element of a binary image I_{Binary} that has the same size as I_{gRGB}. Exemplary value for T_{L} is 0.55, and exemplary value for T_{H} is 0.70. FIG. 7 (a) illustrates the thresholding operation range.

Image 832 is an exemplary binary image I_{Binary} of image 802 after the thresholding operation 906. Pixels having value 1 in the binary image I_{Binary} are the foreground pixels. Foreground pixels are grouped in step of Foreground Pixel Grouping 908 to form clusters such as cluster 834. A cluster is a non-empty set of 1-valued pixels with the property that any pixel within the cluster is also within a predefined distance to another pixel in the cluster. Step 908 groups binary pixels into clusters based upon this definition of a cluster. However, it will be understood that pixels may be clustered on the basis of other criteria.

Under certain circumstances, a cluster of pixels may not be valid. Accordingly, a step of validating the clusters is needed. It is shown in FIG. 9 as Cluster Validation step 910. A cluster may be invalid, if it contains too few binary pixels to acceptably determine the presence of an abnormality. For example, if the number of pixels in a cluster is less than P, then this cluster is invalid. Example P value could be 3. If there exist one or more valid clusters, an alarm signal will be generated and sent to OR gate 608. This alarm signal is also saved to the examination bundlette for record.

Note that in Equation (1), pixels, pᵢ(m, n), having value less than T_{Low} are excluded from the detection of abnormality. A further explanation of the exclusion is given below for conditions other than the facts stated previously.

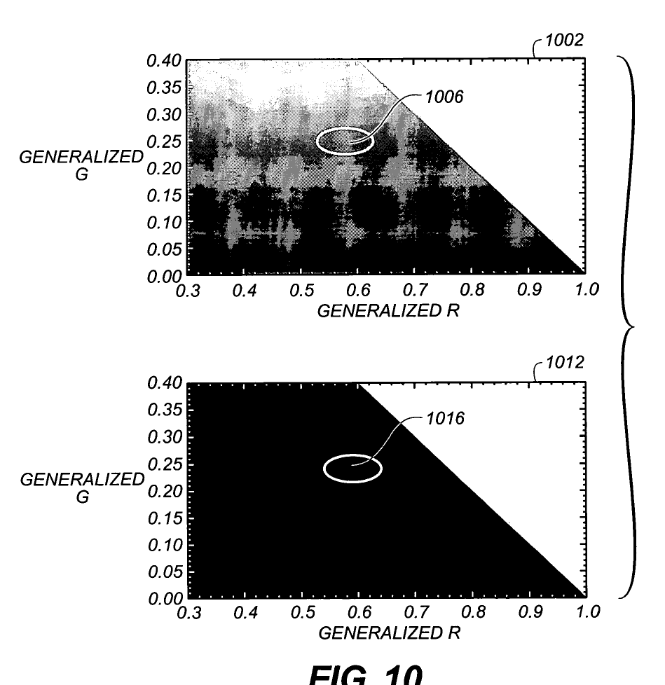

Referring to FIG. 10, there are two graphs 1002 and 1012 showing a portion of the generalized RG space. At every point in the generalized RG space, a corresponding color in the original RGB space fills in. In fact, the filling of original RGB color in the generalized RG space is a mapping from the generalized RG space to the original RGB space. This is not a one to one mapping. Rather, it is a one to many mapping. Meaning that there could be more than one RGB colors that are transformed to a same point in the generalized space. Graphs 1002 and 1012 represent two of a plurality of mappings from the generalized RG space to the original RGB space.

Now in relation to the abnormality detection problem, region 1006 in graph 1002 indicates the generalized R and G values for a disease spot in the gastric fold, and a region 1016 in graph 1012 does the same. Region 1006 maps to colors belonging to a disease spot in the gastric fold in a normal illumination condition. On the other hand, region 1016 maps to colors belonging to places having low reflection in a normal illumination condition. Pixels having these colors mapped from region 1016 are excluded from further consideration to avoid frequent false alarms.

Also note that for more robust abnormality detection, as an alternative, Threshold Detection 906 can use both generalized R and G to further reduce false positives. In this case, the upper threshold parameter T_{H} 905 is a two-element array containing T_{H}^{G} and T_{H}^{R} for generalized G and R respectively. Exemplary values are 0.28 for T_{H}^{G}, and 0.70 for T_{H}^{R}. At the same time, the lower threshold parameter T_{L} 907 is also a two-element array containing T_{H}^{G} and T_{L}^{R} for generalized G and R respectively. Exemplary values are 0.21 for T_{L}^{G}, and 0.55 for T_{L}^{R}. In a transformed in vivo image I_{gRGB}, if the elements \overline{p}₁(m, n) and \overline{p}₂(m, n) of a pixel are between the range of T_{L}^{R} and T_{H}^{R} and the range of T_{L}^{G} and T_{H}^{G}, then the corresponding pixel b(m, n) of the binary image I_{Binary} is set to one. FIG. 7(b) illustrates thresholding ranges for this operation.

FIG. 4 shows an exemplary of an examination bundlette processing hardware system useful in practicing the present invention including a template source 400 and an RF receiver 412 (also 308). The template from the template source 400 is provided to an examination bundlette processor 402, such as a personal computer, or work station such as a Sun Sparc workstation. The RF receiver passes the examination bundlette to the examination bundlette processor 402. The examination bundlette processor 402 preferably is connected to a CRT display 404, an operator interface such as a keyboard 406 and a mouse 408. Examination bundlette processor 402 is also connected to computer readable storage medium 407. The examination bundlette processor 402 transmits processed digital images and metadata to an output device 409. Output device 409 can comprise a hard copy printer, a long-term image storage device, and a connection to another processor. The examination bundlette processor 402 is also linked to a communication link 414 (also 312) or a telecommunication device connected, for example, to a broadband network.

It is well understood that the transmission of data over wireless links is more prone to requiring the retransmission of data packets than wired links. There is a myriad of reasons for this, a primary one in this situation is that the patient moves to a point in the environment where electromagnetic interference occurs. Consequently, it is preferable that all data from the Examination Bundle be transmitted to a local computer with a wired connection. This has additional benefits, such as the processing requirements for image analysis are easily met, and the primary role of the data collection device on the patient's belt is not burdened with image analysis. It is reasonable to consider the system to operate as a standard local area network (LAN). The device on the patient's belt 100 is one node on the LAN. The transmission from the device on the patient's belt 100 is initially transmitted to a local node on the LAN enabled to communicate with the portable patient device 100 and a wired communication network. The wireless communication protocol IEEE-802.11, or one of its successors, is implemented for this application. This is the standard wireless communications protocol and is the preferred one here. It is clear that the Examination Bundle is stored locally within the data collection device on the patient's belt, as well at a device in wireless contact with the device on the patient's belt. However, while this is preferred, it will be appreciated that this is not a requirement for the present invention, only a preferred operating situation. The second node on the LAN has fewer limitations than the first node, as it has a virtually unlimited source of power, and weight and physical dimensions are not as restrictive as on the first node. Consequently, it is preferable for the image analysis to be conducted on the second node of the LAN. Another advantage of the second node is that it provides a “back-up” of the image data in case some malfunction occurs during the examination. When this node detects a condition that requires the attention of trained personnel, then this node system transmits to a remote site where trained personnel are present, a description of the condition identified, the patient identification, identifiers for images in the Examination Bundle, and a sequence of pertinent Examination Bundlettes. The trained personnel can request additional images to be transmitted, or for the image stream to be aborted if the alarm is declared a false alarm.

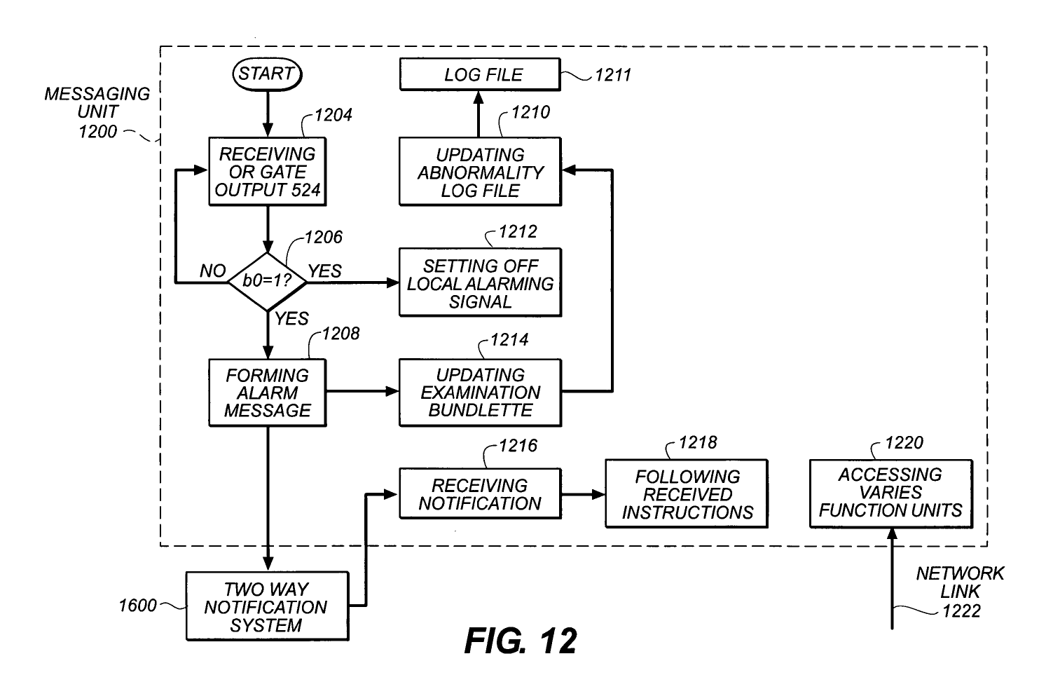

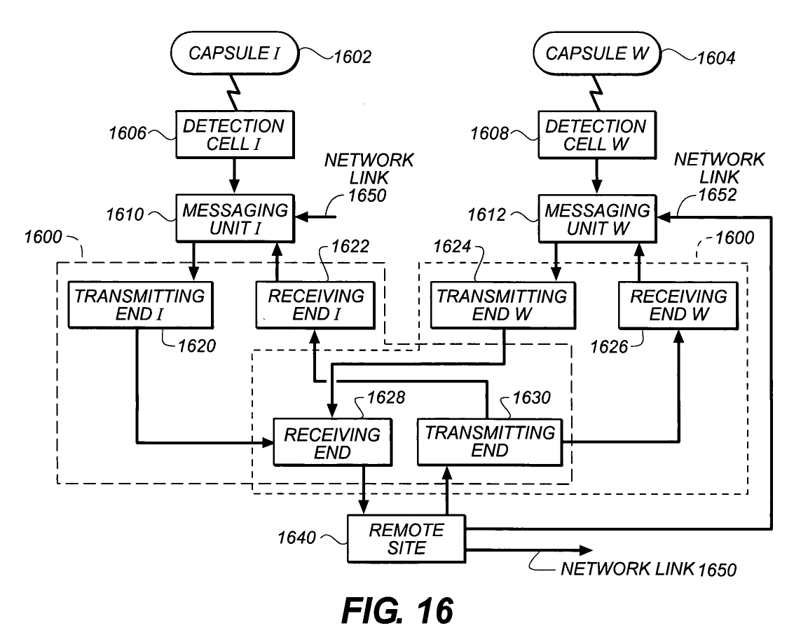

Referring now to FIG. 16, an embodiment of the real-time automatic abnormality notification of in vivo images and remote access of in vivo imaging systems of the present invention will be described. In FIG. 16, there are W, W is equal to or greater than 1, in vivo imaging systems (capsule I (1602), through capsule W (1604)) concurrently capturing and transmitting images. These in vivo imaging systems are represented by system 300 and their functionalities are fully described in previous paragraphs. Capsules I (1602) through W (1604) are swallowed by patients placed in P, P is equal to or less than W, locations. Each capsule has an RF link with a detection cell (detection cell I (1606) through W (1608) for capsules I through W). This detection cell provides functions described earlier in steps 308 and 310. That is, the detection cell receives the transmitted images from the capsule and performs automatic abnormality detection. Instead of using a simple communication link 312 to send an alarm signal to a remote site as described in the embodiment shown in FIG. 3, this embodiment (real-time automatic abnormality notification of in vivo images and remote access of in vivo imaging systems) utilizes a messaging unit 1200 (messaging units I (1610) through W (1612) for detection cell I through W) that provides facilities for intelligent two-way communications with a remote site. This messaging unit also provides local alarm notification and information updating functions. Messaging unit 1200 will be elaborated using FIG. 12 later.

A two-way communication link has two sets of identical transmitting-receiving pairs. Each pair contains a transmitting end and a receiving end (such as 1620-1628, 1630-1622, 1624-1628, and 1630-1626). The transmitting end receives a message from a sender and transmits the message through a type of communication network. The receiving end receives the transmitted message and routes the message to one or more receivers. Notice that in FIG. 16, a remote site 1640 (also 1300) receives random events (unscheduled arrival of alarm messages) from multiple sources. Note that the remote site 1640 (also 1300) contains nurse's station, attending physician offices, etc. At remote site 1640 (also 1300), attending health care workers also return instructions to the patients. In addition, in response to the messages, remote site 1640 (also 1300) performs tasks on individual messaging unit such as 1612 via direct access through a network link 1652, and messaging unit 1610 via direct access through a network link 1650. The two-way communication between the remote site and the individual in vivo imaging system and direct access of the in vivo imaging device greatly elevate detection effectiveness of the in vivo imaging system.

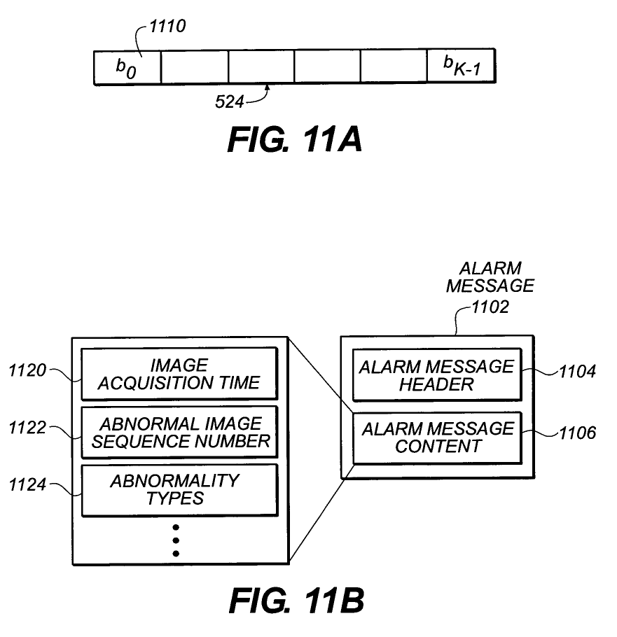

FIG. 12 illustrates the functionalities of an alarm messaging unit 1200. The unit starts its process at a stage 1204 that receives the OR gate output 524. The output 524 is a K bits binary signal as shown in FIG. 11A. A most significant bit b₀ 1110 of the output 524 is initialized as 0 indicating no abnormality detected. If values of the non-image sensed characteristics such as pH 512, pressure 514, temperature 516 and impedance 518 pass over their respective thresholds 511, 515, 517, and 519, corresponding alarm signals are sent to a logic OR gate 522. If any one of the multi-features in image 532 matches its corresponding template or within the ranges specified by the templates, an OR gate 608 sends an alarm signal to the OR gate 522. Any one of these alarm signals turns the most significant bit b₀ 1110 of the output 524 into 1 indicating one or more abnormalities have been detected. The information of the types of abnormality is coded using the rest binary bits of the output 524. The simplest coding scheme is a binary code. Assume K=5. Then there are 2⁴ combinations to code the types of abnormalities. Therefore, a binary signal 10001 could represent an abnormal pH value. 10010 represents an abnormality of pressure. 11001 could represent a Hereditary Hemorrhagic Telangiectasia disease. 10011 could represent both abnormal pH and pressure. The code book is predetermined. However, people skilled in the art may use other schemes to implement information coding.

The most significant bit of the output 524 is checked in step 1206. If there is an indication of abnormality the messaging unit process branches to both steps 1212 and 1208. At step 1212 a physical alarm signal goes off in audible/visual forms.

At step 1208 an alarm message 1102 is formed, referring to FIG. 11B. The alarm message 1102 consists of an alarm message header 1104 and an alarm message content 1106. The alarm message header 1104 contains patient identification information such as name, age, account number, location, the name or identification of the referring physician, the purpose of the examination, and suspected abnormalities and/or detection. This information could be directly obtained from the general metadata 204. In addition, the alarm message header contains an IP (Internet Protocol) address of the computing device that the patient uses, mobile phone numbers, email address and other communication identities.

The alarm message content contains information such as abnormal image acquisition time 1120, abnormal image sequence number 1122 and abnormality types 1124, and any information pertinent to the alarm message content 1106. The alarm message content 1106 is immediately used to update the image packet 206 of the examination bundlette 220 in step 1214. In particular, it updates the inferred image specific data 216 that includes location and description of detected abnormalities within the image, and any pathologies that have been identified.

The messaging unit 1200 provides an abnormality log file 1211 for local and remote quick verification. All alarm messages are recorded in the log file in a step 1210. Alarm messages are also sent to the two-way communication system 1600.

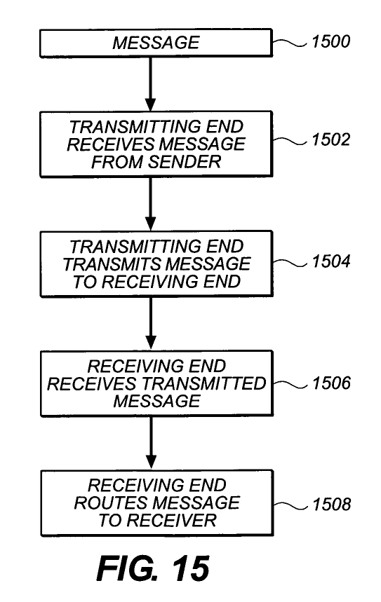

FIG. 15 shows a communication path from the transmitting end to the receiving end (such as 1620-1628, 1630-1622, 1624-1628, and 1630-1626). FIG. 15 represents the steps that take place when a message 1500 is transmitted. The message 1500 could be the alarm message 1200 shown in FIG. 11A or an instruction message 1700 to be discussed later. The communication path receives a message 1500 in a step 1502 of Transmitting end receives message from a sender. The message 1500 is transmitted in a step 1504 of Transmitting end transmits message to receiving end. The receiving end receives the transmitted message in step 1506 and routes the message to a user in step 1508.

The transmitting and receiving message from the transmitting network (including 1502 and 1504) to the receiving network (including 1506 and 1508) is governed by a software platform to simplify the process of delivering messages to a variety of devices including any mobile phones, PDA, pager and other devices. The software platform service can route and escalate notifications intelligently based on rules set up by the user to ensure “closed loop” communication. Routing rules determine who needs access to information, escalation rules set where the message needs to be directed if the initial contact does not respond, and device priority rules let users prioritize their preferred communication devices (e.g., e-mail, pager, cell phone). The platform could be designed to use a web-based interface to make using the two-way communication easy. The hosted service uses Secure Socket Layer (SSQ) technology for logins. The software could be designed to run on any operating system and is based on XML (markup language), Voice XML and J2EE (Java 2 Platform, Enterprise Edition). For voice-only device, the software platform can use text-to-voice conversion technology. The message can be received and responded to on any mobile or wireline phone using any carrier or multiple carriers. An exemplary software platform is a commercially available service INIogicNOW developed by MIR3, Inc.

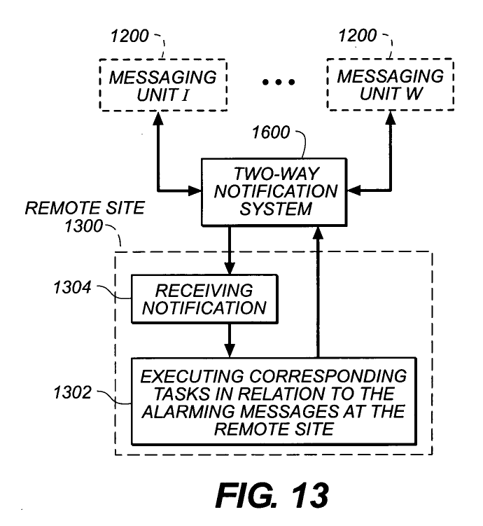

With the aid of the above two-way communication platform 1600, the remote site 1300 in FIG. 13 (also 1640 in FIG. 16) readily accommodate multiple in vivo imaging systems through messaging units I through W (1200). When a health care staff at the remote site 1300 receives a notification of abnormality for a patient at step 1304 the health care staff will respond to the message with a series of actions in a step 1302.

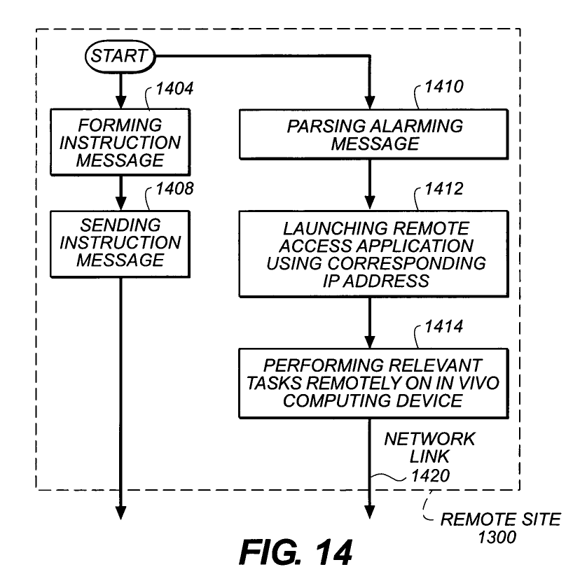

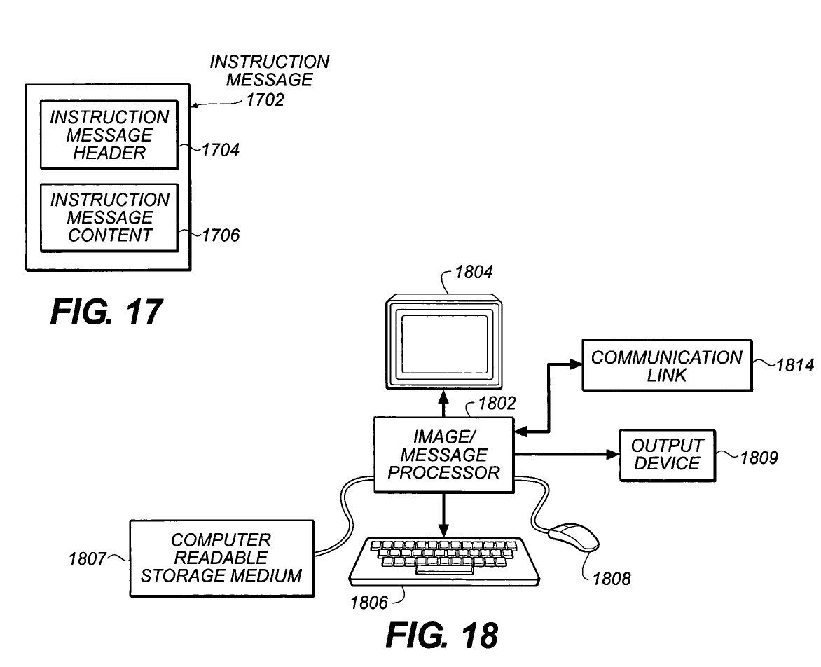

The health care staff first forms/sends out an instruction message 1702 (see FIG. 17) to the patient via steps 1404 and 1408 shown in FIG. 14. The instruction message contains an instruction header 1704 and an instruction content 1706. Directly from the alarm message header 1104, the instruction header 1704 copies the patient identification information such as name, age, account number, location, the name or identification of the referring physician, the purpose of the examination, and suspected abnormalities and/or detection. The instruction header 1704 also contains the remote site health care staff ID number, name, message receiving time and response time.

The instruction content 1706 contains guidelines for the patient to follow. For example, the patient is instructed to lie down, to fast, to see a local health care staff, or to set up an appointment at the remote site. The instruction message 1702 is received by the patient at step 1216 in FIG. 12 through the two-way notification system 1600. The path for transmitting the instruction message is depicted in FIG. 15 and is described in previous paragraphs. The transmitting of the instruction message is again governed by a software platform such as the commercially available service INIogicNOW developed by MIR3, Inc.

At the patient side, after receiving the instruction message the patient takes actions in step 1218.

At the same time, in a step of Parse alarming message 1410, the remote site software parses the alarming message header 1104 to find the patient communication identities such as the IP address. The software then launch remote access application using the corresponding IP address 1412 through a network link 1222 (also 1420). After launching the application, a window appears that shows exactly what's on the screen 404 of the computer system at the patient side. The health care staff at the remote site can access the patient's computer 402 to open folders and documents residing on 402, edit them, print them, install or run programs, view images, copy files between the remote site computer 1802 (see FIG. 18) and the patient's computer 402, restart the patient's computer 402, and so on, exactly as though the health care staff seated in front of patient's computer 402. The connection is encrypted. With that, the remote site health care staff can perform relevant tasks remotely on in vivo computing device 1414 (also 1220).

An exemplary realization of direct access network link is by using a commercially available service GoToMyPc from www.gotomypc.com. There is no dedicated compute hardware system needed. Any computer capable of performing image/message processing and accessing the network could be used. That means that the remote site is itself location unconstrained.

Exemplary tasks, among others, that the remote site health care staff can do including a quick review of the abnormality log file 1211 updated in step 1210, checking in vivo images stored in storage 407 to see if there is a false alarm, retrieving more images for inspection if it is a true positive, downloading stored images from the patient's computing device for further processing and inspection, and increasing image acquisition rate of the in vivo capsule.

FIG. 18 shows an exemplary of a remote site computer hardware system, such as a personal computer, or work station such as a Sun Sparc workstation, useful in practicing the present invention. The system includes an image/message processor 1802 preferably is connected to a CRT display 1804, an operator interface such as a keyboard 1806 and a mouse 1808. Image/message processor 1802 is also connected to computer readable storage medium 1807. The image/message processor 1802 transmits processed digital images and message to an output device 1809. Output device 1809 can comprise a hard copy printer, a long-term image storage device, and a connection to another processor. The examination image/message 1802 is also linked to a communication link 1814 or a telecommunication device connected, for example, to a broadband network.

The invention has been described in detail with particular reference to certain preferred embodiments thereof, but it will be understood that variations and modifications can be effected within the spirit and scope of the invention.

### Parts List

100 Storage Unit
102 Data Processor
104 Camera
106 Image Transmitter
108 Image Receiver
110 Image Monitor
112 Capsule
200 Examination Bundle
202 Image Packets
204 General Metadata
206 Image Packet
208 Pixel Data
210 Image Specific Metadata
212 Image Specific Collection Data
214 Image Specific Physical Data
216 Inferred Image Specific Data
220 Examination Bundlette
300 In Vivo Imaging system
302 In Vivo Image Acquisition
304 Forming Examination Bundlette
306 RF Transmission
306 Examination Bundlette Storing
308 RF Receiver
310 Abnormality Detection
312 Communication Connection
314 Local Site
316 Remote Site
320 In Vitro Computing Device
400 Template source
402 Examination Bundlette processor
404 Image display
406 Data and command entry device
407 Computer readable storage medium
408 Data and command control device
409 Output device
412 RF transmission
414 Communication link
502 Threshold Detector
504 Threshold Detector
506 Threshold Detector
507 Threshold Detector
508 A priori knowledge
510 Examination Bundlette Processing
512 input
514 input
516 input
518 input
511 input
515 input
517 input
519 input
522 OR gate
524 output
532 image
534 templates
536 Multi-feature detector
602 Image feature examiner
604 Image feature examiner
606 Image feature examiner
608 OR gate
802 A color in vivo Image
804 A red spot
812 An R component Image
814 A spot
816 A dark area
822 A generalized R image
824 A spot
832 A binary image
834 A spot
902 Rank-order filtering
904 Color transformation
905 A threshold
906 Threshold Detection
907 A threshold
908 Foreground pixel grouping
910 Cluster validation
1002 A generalized RG space graph
1006 A region
1012 A generalized RG space graph
1016 A region
1102 An alarm message
1104 An alarm message header
1106 An alarm message content
1110 A most significant bit
1120 image acquisition time
1122 abnormal image sequence number
1124 abnormality types
1200 A messaging unit
1204 Receiving OR gate output 524
1206 A query
1208 Forming alarm message
1210 Updating abnormality log file
1211 A log file
1212 Setting off local alarming signal
1214 Updating examination bundlette
1216 Receiving notification
1218 Following received instructions
1220 Accessing varies function units
1222 network link
1300 remote site
1302 Executing Corresponding tasks in relation to the alarming messages at the remote site
1304 Receiving notification
1404 Forming instruction message
1408 Sending instruction message
1410 Parsing alarming message
1412 Launching remote access application using corresponding IP address
1414 Performing relevant tasks remotely on in vivo computing device
1420 Network link
1500 Message
1502 Transmitting end receives message from sender
1504 Transmitting end transmits message to receiving end
1506 Receiving end receives transmitted message
1508 Receiving end routes message to receiver
1600 Two way notification system
1602 Capsule I
1604 Capsule M
1606 Detection cell I
1608 Detection cell M
1610 Messaging unit I
1612 Messaging unit M
1620 Transmitting end I
1622 Receiving end I
1624 Transmitting end M
1626 Receiving end M
1628 Receiving end
1630 Transmitting end
1640 Remote Site
1650 network link
1652 network link
1702 Instruction message
1704 Instruction message header
1706 Instruction message content
1802 image/message processor
1804 display
1806 data and command entry device
1807 computer readable storage medium
1808 data and command control device
1809 output device
1814 communication link

1. An automatic notification and remote access method for diagnosing real-time in vivo images from a location remote from one or more in vivo video camera systems, comprising the steps of:
a) capturing multiple sets of real-time in vivo images using the one or more in vivo video camera systems;
b) forming an in vivo video camera system examination bundlette of a patient that includes the real-time captured in vivo images for each of the one or more in vivo video camera systems;
c) processing the examination bundlette;
d) automatically detecting one or more abnormalities in the examination bundlette based on predetermined criteria for the patient;
e) signaling an alarm provided that the one or more abnormalities in the examination bundlette have been detected;
f) receiving an automatic notification via one or more unscheduled alarming messages from one or more randomly located in vivo video camera systems;
g) routing the automatic notification to remote recipient(s); and
h) executing one or more diagnosing tasks corresponding to the automatic notification.

2. The method claimed in claim 1, wherein the unscheduled alarming messages correspond to a detection of an abnormality found in the patient's GI tract.

3. The method claimed in claim 1, wherein the automatic notification includes patient metadata describing the patient's medical history and location.

4. The method claimed in claim 1, wherein the one or more randomly located in vivo video camera systems are located in different geographic regions of a country and/or a continent.

5. The method claimed in claim 1, wherein the step of routing the automatic notification to the remote recipient(s), further comprises the steps of:
G1) providing a communication channel to the remote recipient(s); and
g2) providing the remote recipient(s) with the automatic notification of a detected GI tract abnormality.

6. The method claimed in claim 1, wherein the unscheduled alarming messages operate within a two-way messaging system.

7. The method claimed in claim 1, wherein the remote recipient receives messages by utilizing a two-way messaging system.

8. The method claimed in claim 1, wherein the remote access is accomplished by a communications network for retrieving and/or sending the patient's in vivo images from multiple locations either inside or outside of a clinical environment.

9. The method claimed in claim 1, wherein the step of forming the examination bundlette, includes the steps of:
b1) forming an image packet of the captured in vivo images of the patient;
b2) forming patient metadata; and
b3) combining the image packet and the patient metadata into the examination bundlette.

10. The method claimed in claim 1, wherein the step of processing the examination bundlette, includes the steps of:
b1) separating the in vivo images from the examination bundlette; and
b2) processing the in vivo images according to selected image processing methods.
